(19) United States
(12) Patent Application Publication
(10) Pub. No.: US 2006/0282383 A1
(43) Pub. Date: Dec. 14, 2006

(54) Payment methods and systems enhanced with image comparison for detecting fraudulent checks

(75) Inventor: Wayne M. Doran, Kitchener (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/148,633

(22) Filed: Jun. 9, 2005

(51) Int. Cl. G06Q 40/00

(52) U.S. Cl. 705/45

(57) ABSTRACT

A method of a paying bank processing a check which has been presented for payment comprises the steps of (a) receiving a check from a presenting bank, (b) verifying the check of step (a) based upon details contained in a check data file which has been previously received from a payor of the check, and (c) verifying the check based upon details contained in a check image file which also has been previously received from the payor of the check when the check is unable to be verified in step (b). The check data file may comprise a positive pay file. Step (c) may include the sub-steps of (c-1) capturing image data from the check, and (c-2) comparing the captured image data of sub-step (c-1) with at least a portion of a previously scanned image of the check stored in the check image file to verify the check. The at least a portion of a previously scanned image of the check may comprise a full image of the check. The check image file may include image data which is representative of full images of checks. The method may further comprise the step of (d) approving payment to the presenting bank only when the check has been verified in either step (b) or step (c).

### BACKGROUND

An embodiment of the present invention relates to fraudulent check detection, and is particularly directed to payment methods and systems enhanced with image comparison for detecting fraudulent checks.

Check fraud is a problem which is costing banks significant amounts of money. One type of check fraud includes counterfeiting a check. Another type of check fraud includes forging a payor signature on a legitimate blank check. Still another type of check fraud includes altering a legitimate check, such as altering the amount of the check or altering the payee of the check.

There are a number of known products available in the marketplace to detect fraudulent checks. One such product is a “positive pay” system in which a payor of a check provides his/her bank (i.e., the paying bank) with details of issued checks. These details are contained in a positive pay file which is electronically sent from the check payor to the paying bank. When a presenting bank presents one of the issued checks to the paying bank, the paying bank captures check data from the presented check and compares the captured check data to check details retrieved from the positive pay file to verify that the presented check has not been altered. The comparison is based primarily on the amount of the check and the serial number of the check to enable the paying bank to catch altered check amounts and duplicate checks. A known enhancement to positive pay systems also captures the payee name to verify that the presented check has not been altered. These enhanced positive pay systems are known as “payee positive pay” systems.

### SUMMARY

In accordance with an embodiment of the present invention, a method of a paying bank processing a check which has been presented for payment comprises the steps of (a) receiving a check from a presenting bank, (b) verifying the check of step (a) based upon details contained in a check data file which has been previously received from a payor of the check, and (c) verifying the check based upon details contained in a check image file which also has been previously received from the payor of the check when the check is unable to be verified in step (b).

The check data file may comprise a positive pay file. Step (c) may include the sub-steps of (c-1) capturing image data from the check, and (c-2) comparing the captured image data of sub-step (c-1) with at least a portion of a previously scanned image of the check stored in the check image file to verify the check. The at least a portion of a previously scanned image of the check may comprise a full image of the check. The check image file may include image data which is representative of full images of checks. The method may further comprise the step of (d) approving payment to the presenting bank only when the check has been verified in either step (b) or step (c).

### BRIEF DESCRIPTION OF THE DRAWINGS

In the accompanying drawings:

FIG. 1 is a schematic diagram representation of an example system embodying the present invention; and

FIG. 2 is a flow diagram which depicts steps of a process in accordance with an embodiment of the present invention.

### DETAILED DESCRIPTION

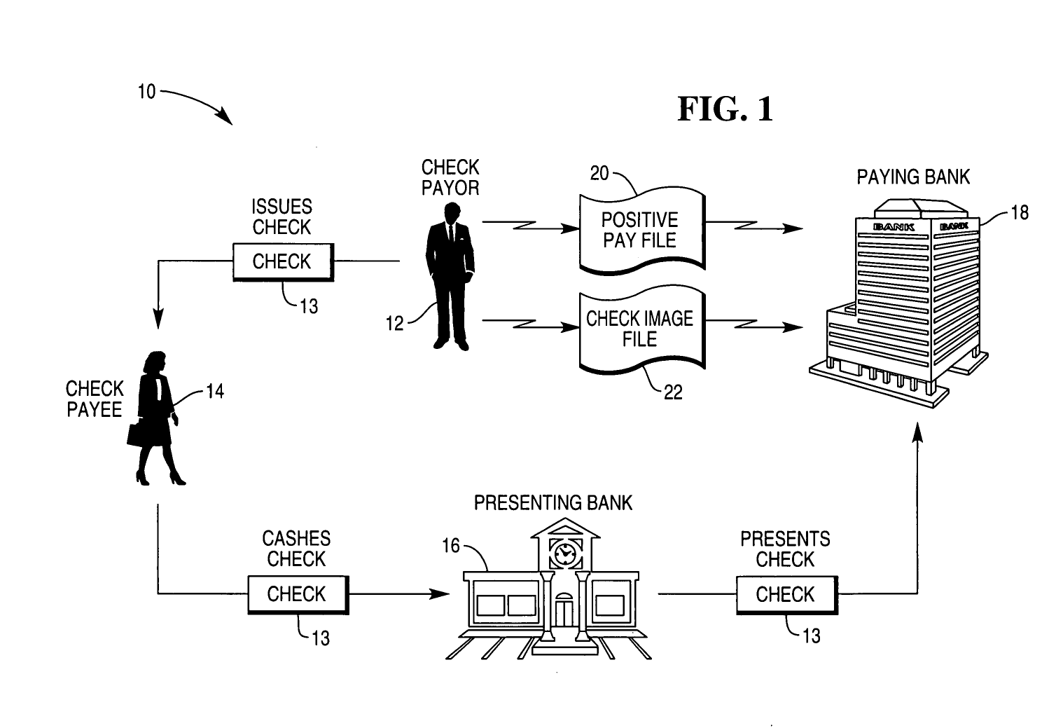

An embodiment of the present invention is directed to payment methods and systems enhanced with image comparison for detecting fraudulent checks. A system 10 embodying the present invention is illustrated in FIG. 1. As shown in FIG. 1, a check payor 12 issues a check 13 to a check payee 14 who, in turn, cashes the check at a presenting bank 16. The presenting bank 16 then presents the check 13 to a paying bank 18 in conventional manner. The paying bank 18 is the same bank that originally provided the payor 12 with blank checks to issue to various payees including the payee 14.

When the check payor 12 issues the check 13 to the check payee 14, as just described hereinabove, the check payor electronically transmits a positive pay file 20 to the paying bank 18. The positive pay file 20 and the process of electronically sending the positive pay file to the paying bank 18 are conventional and, therefore, will not be described in detail. Briefly, the positive pay file 20 includes details of checks which have been issued by the check payor 12. Thus, the positive pay file 20 includes details of the particular check 13 which the check payor 12 issued to the check payee 14.

The check payor 12 also creates a check image file 22 and electronically transmits it to the paying bank 18. The check image file 22 includes image data which is representative of full images of completed checks which have been issued by the check payor 12. A completed check is a check which has been filled in by the check payor 12 for the purpose of subsequently issuing to a designated check payee. Thus, the check image file 22 includes image data which is representative of a full image of the particular check 13 which the check payor 12 issued to the check payee 14. The check payor 12 may use, for example, a conventional type of scanner to scan the issued checks to create the check image file 22.

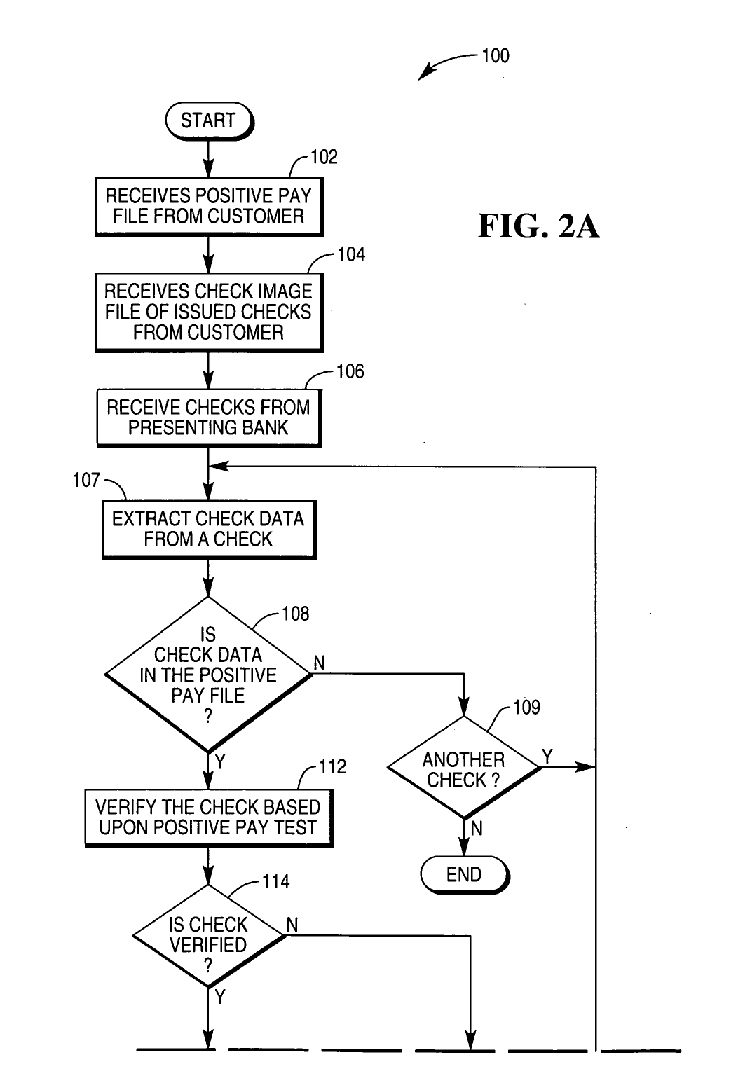

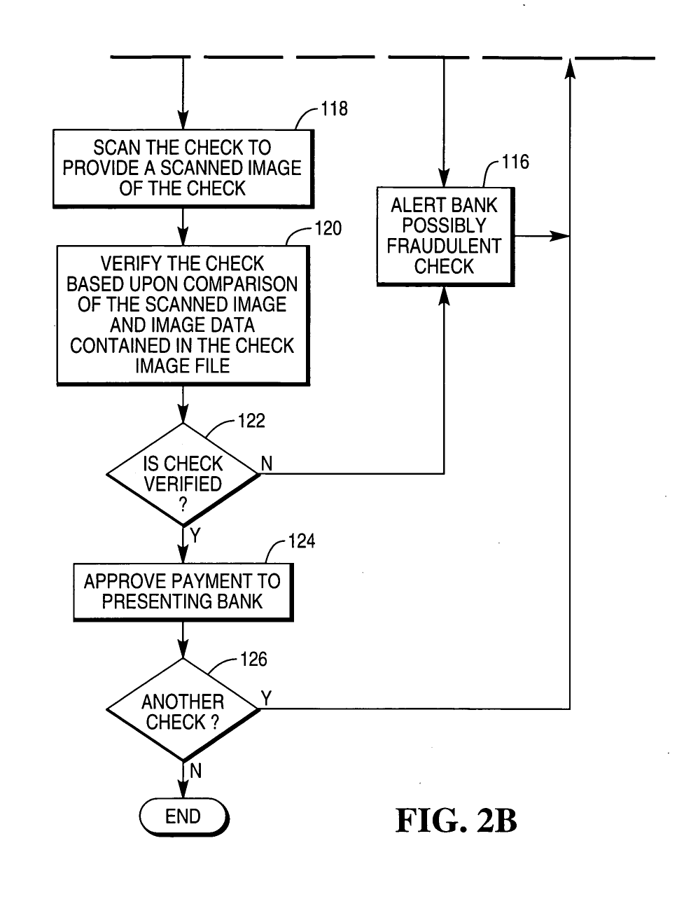

Referring to FIG. 2, a flow diagram 100 depicts steps of a process in accordance with the present invention. In step 102, the paying bank 18 receives the positive pay file 20 from the check payor 12. Also, as shown in step 104, the paying bank 18 receives the check image file 22 from the check payor 12. Further, the paying bank 18 receives checks from the presenting bank 16 requesting payment for the checks, as shown in step 106. In step 107, check data, such as check account number and check serial number, is extracted from a check (e.g., the check 13).

A determination is made in step 108 as to whether or not the check 13 has corresponding check data contained in the positive pay file 20 which has been received from the check payor 12. If there is no corresponding check data contained in the positive pay file 20, the process proceeds to step 109 to determine if there is another check to be processed. If there is not another check to be processed, the process ends. However, if there is another check to be processed, the process returns to step 107 to process this next check.

If there is corresponding check data contained in the positive pay file 20 as determined in step 108, the process proceeds to step 112 to verify that the check 13 has not been altered. The verification occurring in step 112 is based upon a number of conventional positive pay tests, as is known. A determination is then made in step 114 as to whether or not the check 13 has been verified in step 112. If the determination in step 114 is negative, the process proceeds to step 116 to alert a person at the paying bank 18 of a possible fraudulent check. However, if the determination in step 114 is affirmative, the process proceeds to step 118.

In step 118, a person at the paying bank 18 scans the check 13 using, for example, a conventional scanner to provide a scanned image of the check. Then, the check 13 is verified, as shown in step 120. The verification occurring in step 120 is based upon a full image comparison of the scanned check image provided in step 118 and a check image which is represented by image data which is contained in the check image file 22. More specifically, the check image from the check image file 22 is an image of the check “as issued” by the check payor 12 to the check payee 14.

The full image comparison described above compares a master image and a target image to detect variation between the images. Variations between the images may be detected in a number of different places. For examples, variations may be detected in “name of payor”, “name of payee”, “amount of the check”, “routing number”, “account number”, or “serial number of the check”.

There are a number of image matching techniques available to perform the full image comparison. For example, one image matching technique is to construct a pixel-by-pixel comparison of an “object” image (the scanned check image provided in step 118) and a “target” image (represented by image data which is contained in the check image file 22). The differences between the two pixel values at each point in the target and object images are calculated and stored in a matrix. This operation creates a new image (i.e., a “difference” image) which represents the differences between the object and target images at each pixel point. If the two images are exactly the same, the matrix representing the “difference” image would contain all zeros. Pixel positions, or runs of connected pixels, in the “difference” image that have values exceeding a pre-determined threshold in areas of interest are flagged as representing possible fraudulent alterations that need to be reviewed by the person at the paying bank 18.

As another example, another image matching technique, which is slightly more sophisticated than the image matching technique described hereinabove, is to use a process known as cross correlation. The process of cross correlation is useful in situations where the object image is slightly displaced horizontally, vertically or both, from the target image. In this process, a cross correlation function is created by shifting the “object” image pixel by pixel across the “target” image. In each position, a cross correlation coefficient between the object and target image is computed according to known cross correlation algorithms. The position that yields the maximum value for the cross correlation coefficient defines the position of the best match between the target and object images. The “difference” image can then be computed as previously described with the target and object images held in the relative positions representing the highest degree of correlation.

Pre-processing techniques may be applied to either the target image or the object image, or both, to improve performance of the full image comparison. Such pre-processing techniques may include image binarization, line width normalization, and various geometric mappings (such as data rotation, de-skewing, scaling, stretching, compacting, shifting).

A determination is then made in step 122 as to whether or not the check 13 has been verified. If the determination in step 122 is negative, the process proceeds to step 116 to alert a person at the paying bank 18 of a possible fraudulent check. However, if the determination in step 122 is affirmative, the process proceeds to step 124 in which approval is provided to make payment in the amount of the check 13 to the presenting bank 16.

The process then proceeds to step 126 in which a determination is made as to whether another check is available to be processed. If the determination in step 126 is affirmative, the process returns to step 107 to process the next check. Otherwise, the process ends.

Although the above description describes the presenting bank 16 presenting a physical check to the paying bank 18, it is conceivable that the presenting bank may present an image of the check, instead of the physical check, to the paying bank. The presenting bank 16 would electronically transmit the image of the check to the paying bank 18. In this case, the paying bank 18 would not need to scan a physical check before being able to compare an image of the check with a check image from the check image file 22.

Also, although the above description describes the check payor 12 electronically transmitting the positive pay file 20 to the paying bank 18, it is conceivable that a check data file which is other than a positive pay file be electronically transmitted instead of the positive pay file. It is conceivable that the check data file includes check information such as the check account number and check serial numbers of completed checks which have been issued by the check payor 12.

Although the above description describes the check payor 12 sending full images of completed checks to the paying bank 18, it is conceivable that partial images of checks may be sent instead of full images. It is also conceivable that full images of checks may be sent, but that the verification occurring in step 120 described hereinabove for each check may be based upon only a portion of the full image for that particular check.

It should be apparent that at least some fraudulent checks which are currently undetected using known positive pay systems can be detected by using a payment method and system enhanced with image comparison, such as described hereinabove.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a paying bank processing a check which has been presented for payment, the method comprising the steps of:
(a) receiving a check from a presenting bank;
(b) verifying the check of step (a) based upon details contained in a check data file which has been previously received from a payor of the check; and
(c) verifying the check based upon details contained in a check image file which also has been previously received from the payor of the check when the check is unable to be verified in step (b).

2. A method according to claim 1, wherein the check data file comprises a positive pay file.

3. A method according to claim 1, wherein step (c) includes the sub-steps of:
(c-1) capturing image data from the check; and
(c-2) comparing the captured image data of sub-step (c-1) with at least a portion of a previously scanned image of the check stored in the check image file to verify the check.

4. A method according to claim 3, wherein the at least a portion of a previously scanned image of the check comprises a full image of the check.

5. A method according to claim 1, wherein the check image file includes image data which is representative of full images of checks.

6. A method according to claim 1, further comprising the step of:
(d) approving payment to the presenting bank only when the check has been verified in either step (b) or step (c).

7. A payment method comprising the steps of:
(a) receiving from a bank customer a check data file which contains non-image details of completed checks to be issued by the bank customer;
(b) receiving from the bank customer an image file which contains image details of the completed checks to be issued by the bank customer;
(c) receiving from a presenting bank one of the completed checks which has been issued by the bank customer;
(d) capturing data from the check received in step (c);
(e) comparing the captured data of step (d) with non-image check details contained in the check data file to verify the check received in step (c); and
(f) comparing the captured data of step (d) with image check details contained in the image file to verify the check received in step (c) when the check is unable to be verified in step (e).

8. A payment method according to claim 7, wherein the check data file comprises a positive pay file.

9. A payment method according to claim 7, wherein the image details contained in the image file comprise full images of completed checks.

10. A payment method according to claim 7, further comprising the step of:
(g) approving payment to the presenting bank only when the check has been verified in either step (e) or step (f).

11. A payment system comprising:
means for receiving from a bank customer a check data file which contains non-image details of completed checks to be issued by the bank customer;
means for receiving from the bank customer an image file which contains image details of the completed checks to be issued by the bank customer;
means for receiving from a presenting bank one of the completed checks which has been issued by the bank customer;
means for capturing data from the check received from the presenting bank;
means for comparing the captured data with non-image check details contained in the check data file to verify the check received from the presenting bank; and
means for comparing the captured data with image check details contained in the image file to verify the check received from the presenting bank when the check is unable to be verified based upon the comparison of the captured data with the non-image check details contained in the check data file.
